(19) United States
(12) Patent Application Publication
(10) Pub. No.: US 2004/0262121 A1
(43) Pub. Date: Dec. 30, 2004

(54) Banknote acceptor

(76) Inventors: Tien-Yuan Chien, Taipei City (TW); Shoe-Po Chan, Taipei City (TW); Yeuh-Ping Hsu, Taipei Hsien (TW)

Correspondence Address: RABIN & BERDO, P.C., Suite 500, 1101 14th Street, N.W., Washington, DC, 20005, US

(21) Appl. No.: 10/602,589

(22) Filed: Jun. 25, 2003

(51) Int. Cl. G07F 7/00; G07D 7/00; G06K 7/00; G07F 7/04; G06K 9/00; G06M 1/00; G06M 3/00; G07F 9/08

(52) U.S. Cl. 194/207; 194/205; 194/215

(57) ABSTRACT

A banknote acceptor is disclosed to have a banknote verification assembly adapted to verify the authenticity of the inserted banknote by means of an optical transmitter module, which uses an UV LED to emit UV light through the inserted banknote, and an optical receiver module, which uses a phototransistor to receive light passing from the UV LED through the banknote and to produce a corresponding output signal, for enabling a control unit to determine the authenticity of the banknote subject to the nature of the output signal received from the photo transistor.

### BACKGROUND OF THE INVENTION

1. Field of the Invention

The present invention relates to vending machines and the like and, more specifically, to a banknote acceptor for use in a vending machine or money exchanging machine, which uses ultraviolet light to verify the authenticity of the inserted banknote.

2. Description of the Related Art

In public places, vending machines are provided to sell different items. Regular vending machines include two types, one accepting coins and the other accepting banknotes. A banknote accepting vending machine has verification means to verify the authenticity of the inserted banknote. However, conventional banknote acceptors do not use ultraviolet light to verify the ink characteristics of banknotes. Following the employment of high-tech equipment, counterfeit banknotes and genuine banknotes are quite similar in outer appearance and other several characteristics. Regular banknote acceptors may not be able to accurately verify the authenticity of banknotes.

### SUMMARY OF THE INVENTION

The present invention has been accomplished under the circumstances in view. It is the main object of the present invention to provide a banknote acceptor, which uses ultraviolet light to verify the authenticity of the inserted banknote.

According to the present invention, the banknote acceptor comprises a housing, the housing comprising an insertion slot in a face panel thereof for receiving banknote, and a conveying and banknote holding down mechanism; a money box mounted in the housing and adapted to collect banknote from the insertion slot; and a banknote verification assembly mounted in the housing and adapted to verify the authenticity of the inserted banknote, for enabling the verified banknote to be delivered to the inside of the money box by the conveying and banknote holding down mechanism; wherein the banknote verification assembly comprises a transmitter holder base, the transmitter holder base having a detection side; a receiver holder base, the receiver holder base having a detection side facing the detection side of the transmitter holder base; a banknote passage defined between the detection side of the transmitter holder base and the detection side of the receiver holder base in communication between the insertion slot and the money box; an optical transmitter module mounted in the detection side of the transmitter holder base, the optical transmitter module comprising at least one ultraviolet light emitting diode adapted to emit ultraviolet light onto the banknote being delivered from the insertion slot through the banknote passage; an optical receiver module mounted in the detection side of the receiver holder base, the optical receiver module comprising at least one photo transistor adapted to receive light passing from the optical transmitter module through the banknote being delivered from the insertion slot through the banknote passage and to produce a corresponding output signal; and a control unit adapted to receive outputted signal from the optical receiver module and to determine the authenticity of the banknote being delivered from the insertion slot through the banknote passage subject to the output signal received from the optical receiver module.

### BRIEF DESCRIPTION OF THE DRAWINGS

FIG. 1 is an exploded view of a banknote acceptor according to the present invention.

FIG. 1A is a side view in section of the banknote acceptor according to the present invention.

FIG. 2 is a circuit block diagram of the present invention.

FIG. 3 is a circuit diagram of the optical transmitter module and the optical receiver module according to the present invention.

FIG. 4 is a detailed circuit diagram of the optical transmitter module according to the present invention.

FIG. 5 is a detailed circuit diagram of the optical receiver module according to the present invention.

FIG. 6A is a circuit diagram of the control unit according to the present invention (I).

FIG. 6B is a circuit diagram of the control unit according to the present invention (II).

FIG. 6C is a circuit diagram of the control unit according to the present invention (III).

FIG. 6D is a circuit diagram of the control unit according to the present invention (IV).

FIG. 7 is a circuit diagram of the power module according to the present invention.

FIG. 8A is a circuit diagram of the communication interface module according to the present invention (I).

FIG. 8B is a circuit diagram of the communication interface module according to the present invention (II).

FIG. 9 is a circuit diagram of the transmission module according to the present invention.

FIG. 10 is an operation flow of the present invention.

### DETAILED DESCRIPTION OF THE PREFERRED EMBODIMENT

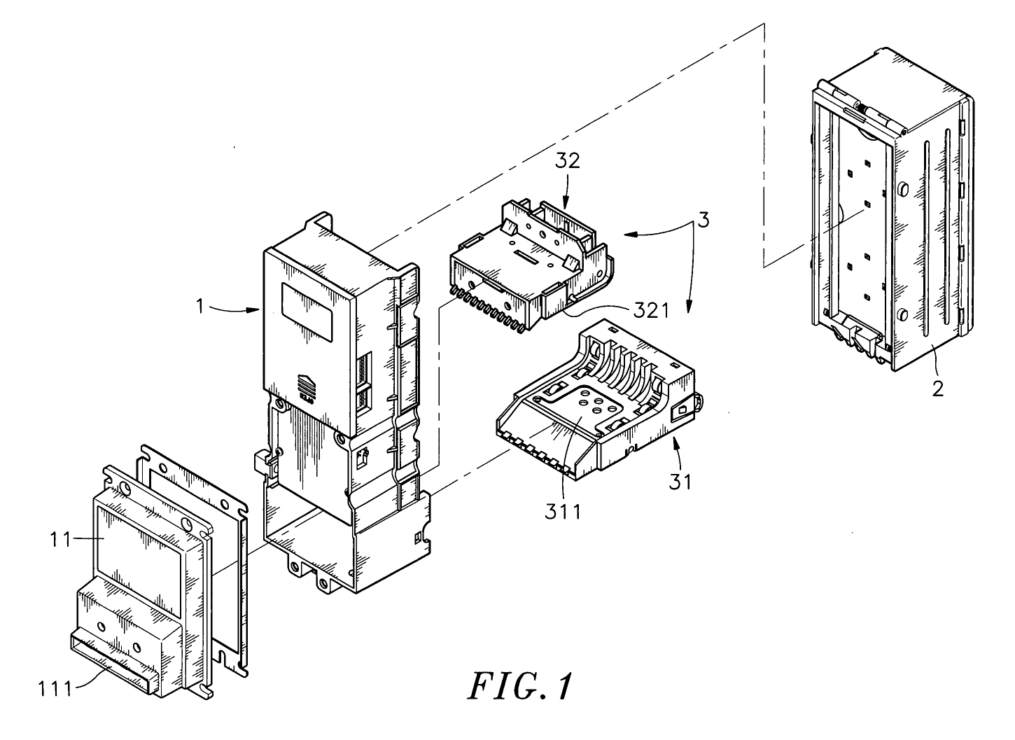

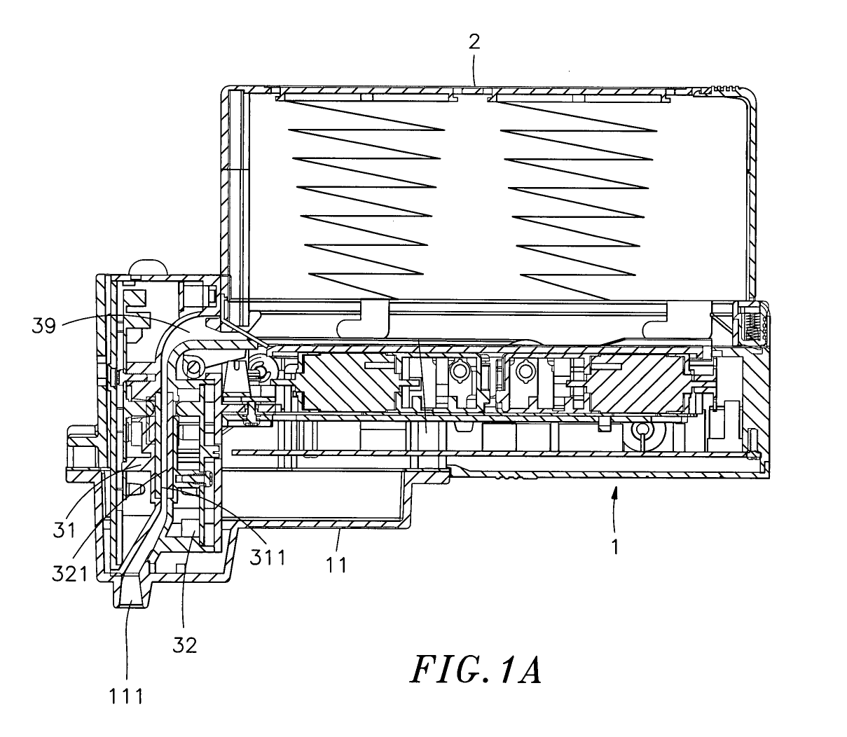

Referring to FIGS. 1 and 1A, a banknote acceptor is shown comprised of a housing 1, a money box 2, and a banknote verification assembly 3.

The housing 1 is provided with a face panel 11, which has an insertion slot 111 through which a banknote is inserted into the banknote verification assembly 3. The money box 2 and the banknote verification assembly 3 are mounted in the housing 1 at different elevations. The banknote verification assembly 3 is adapted to verify the authenticity of the inserted banknote, for enabling the verified banknote to be delivered to the inside of the money box 2 by a conveying and banknote holding down mechanism (not shown) in the housing 1.

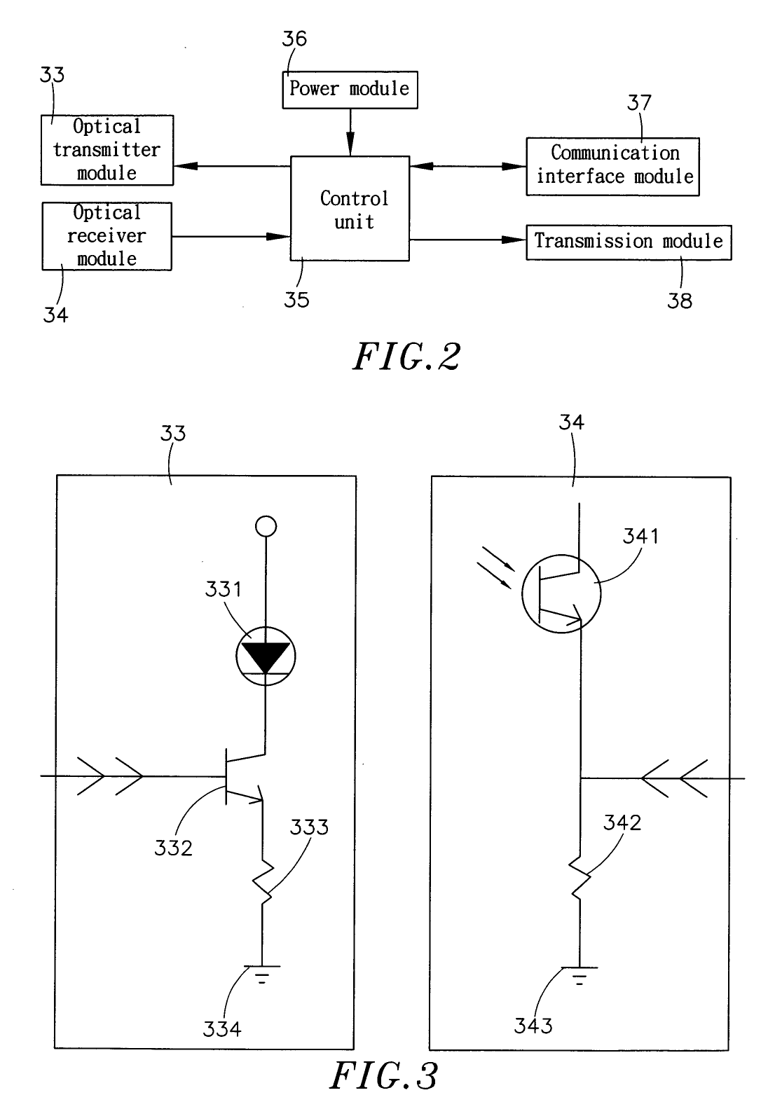

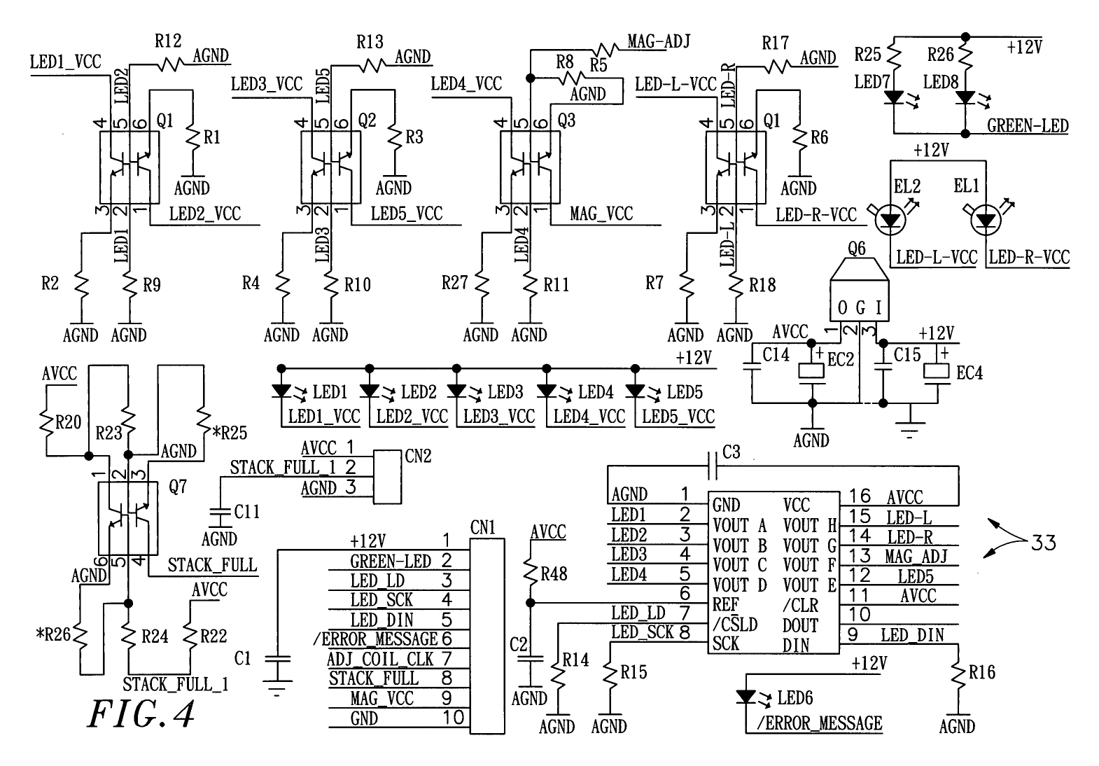

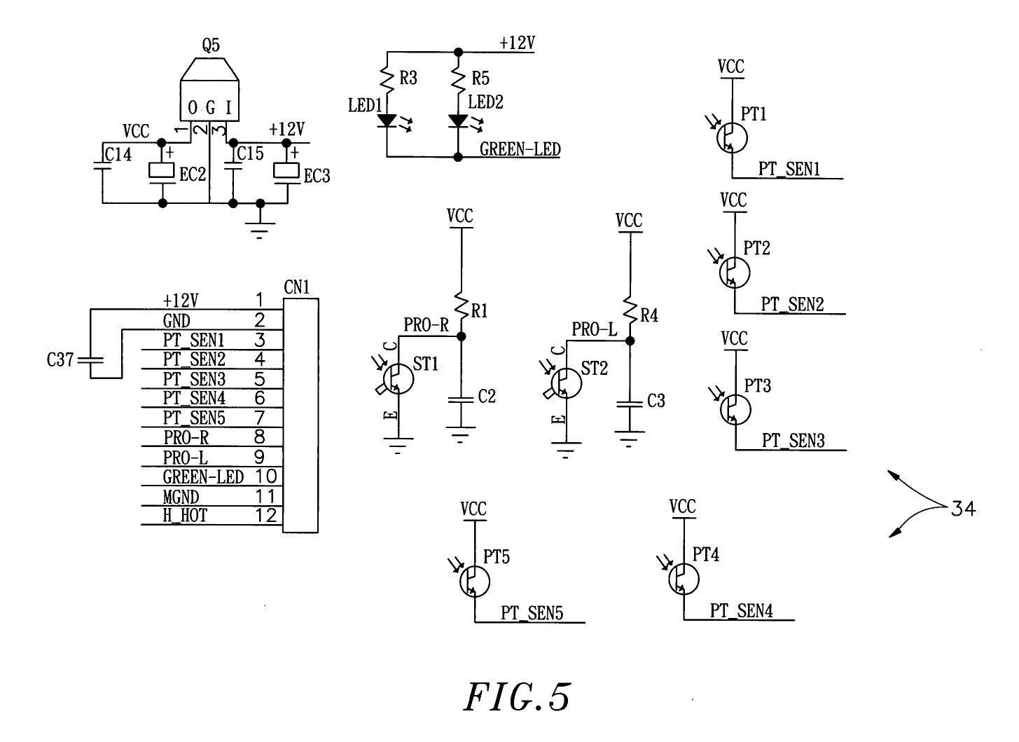

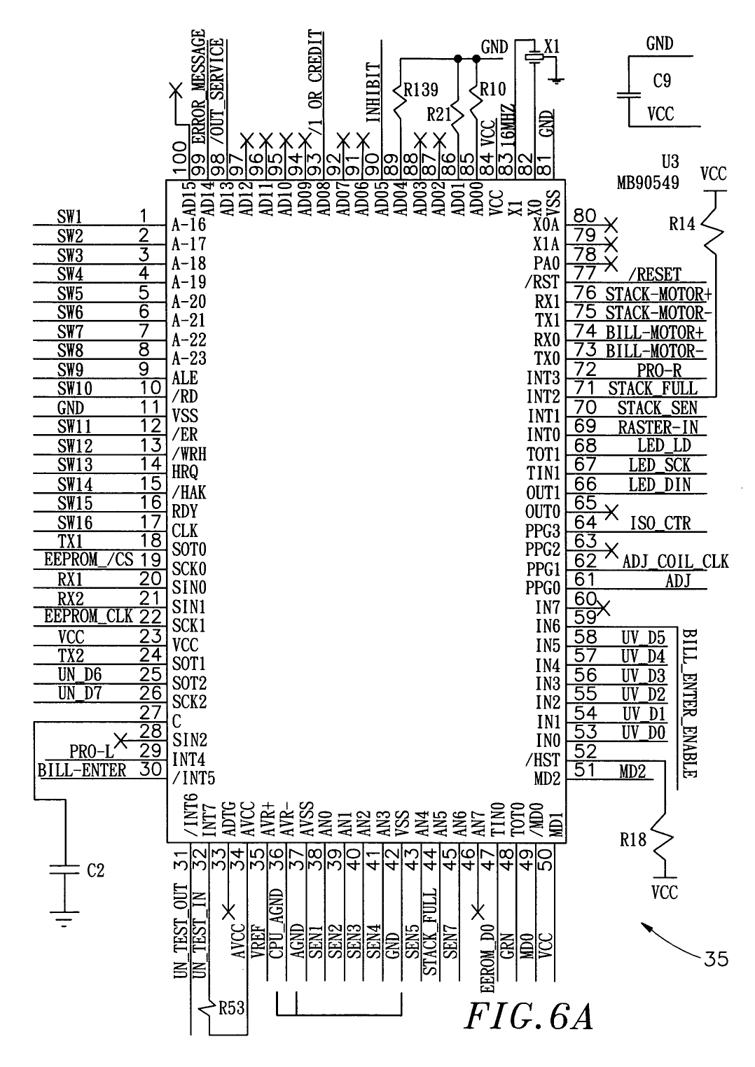

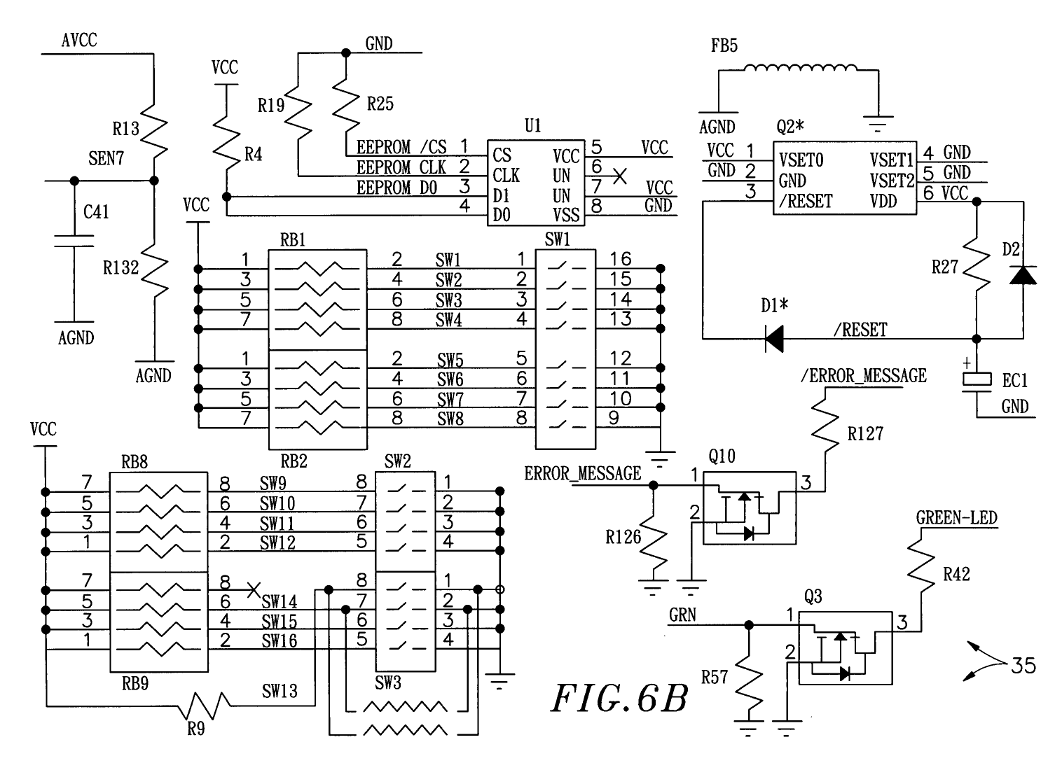

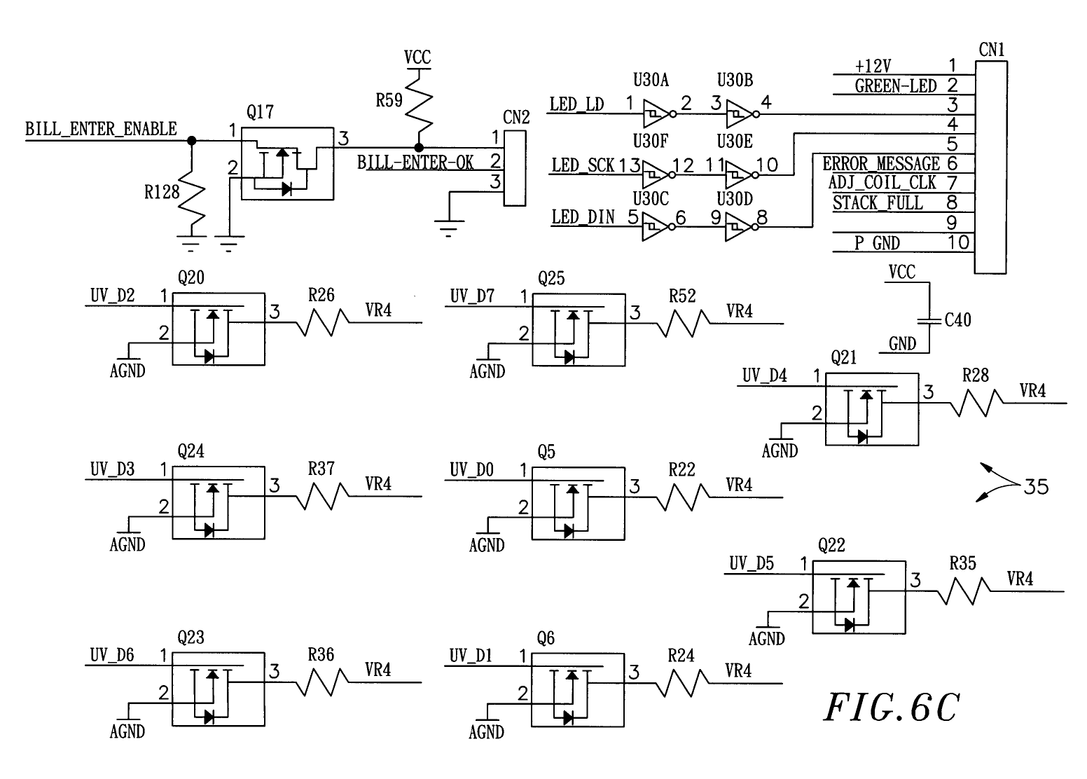

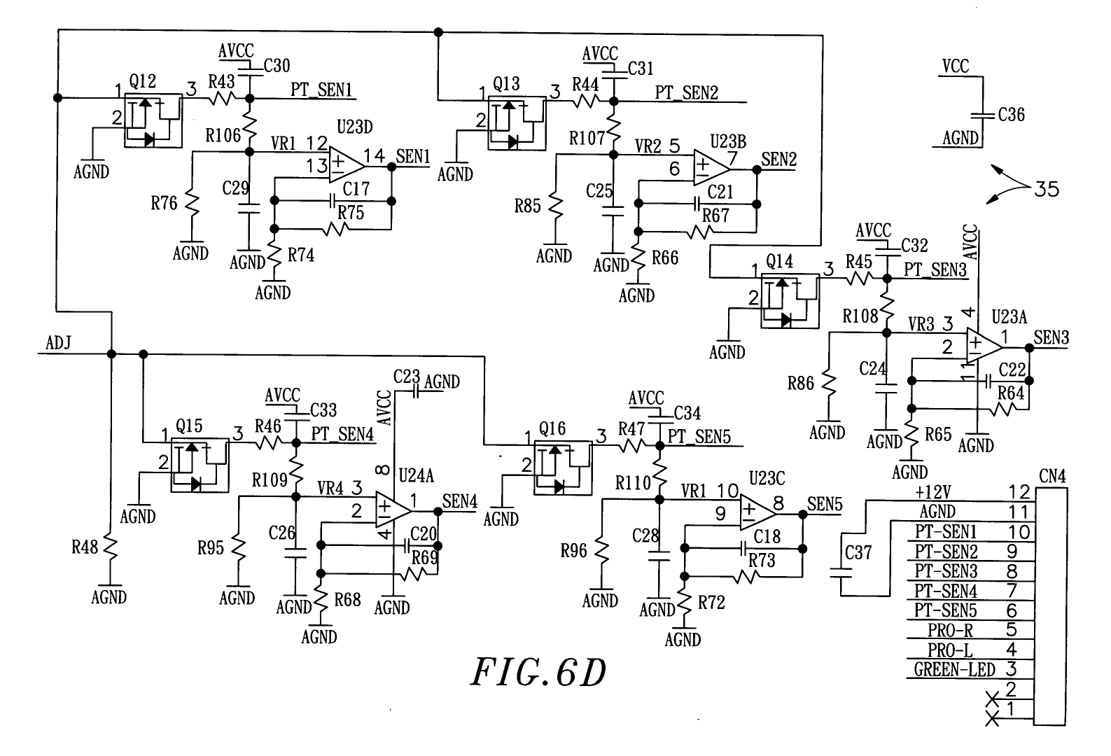

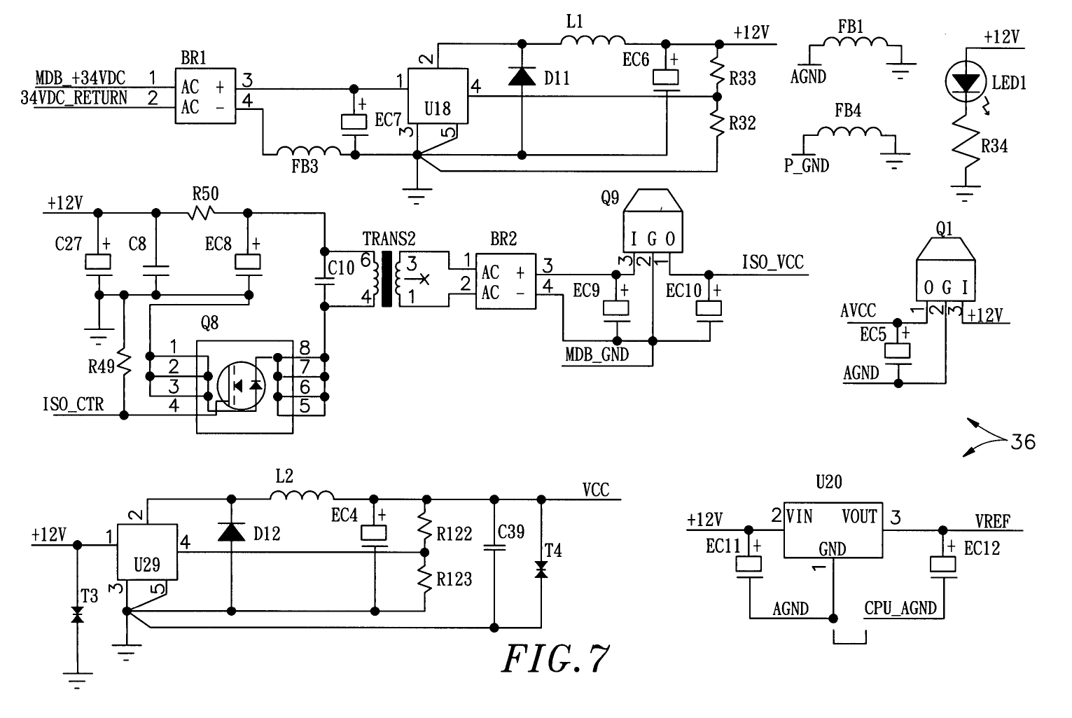

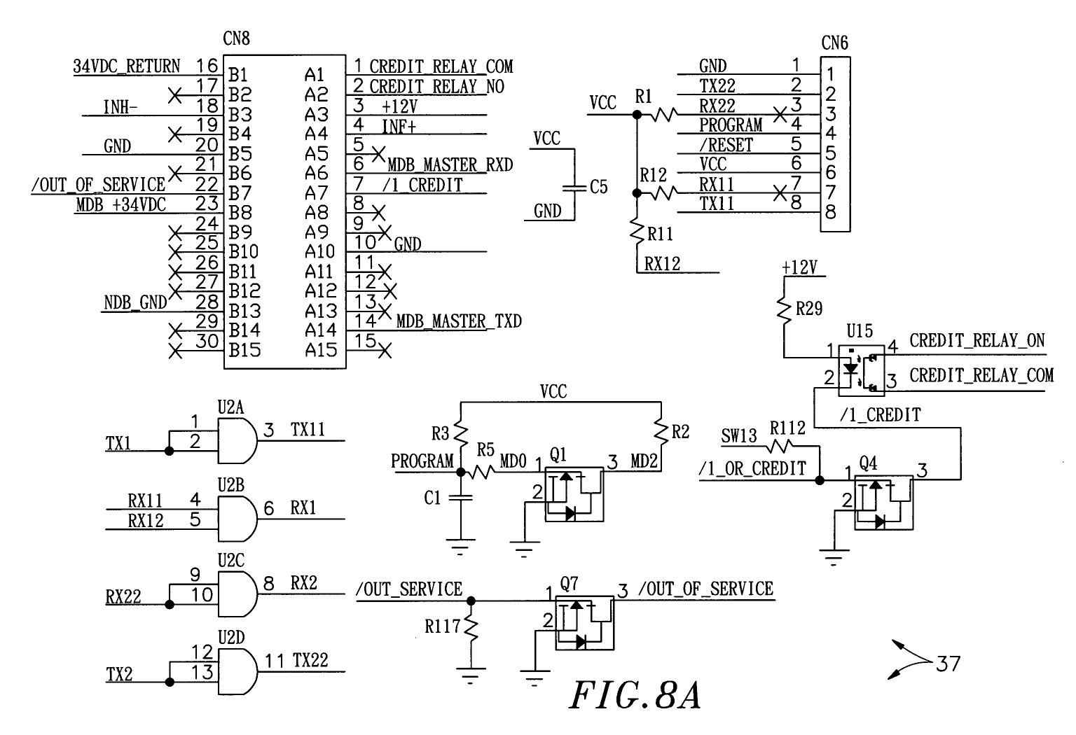

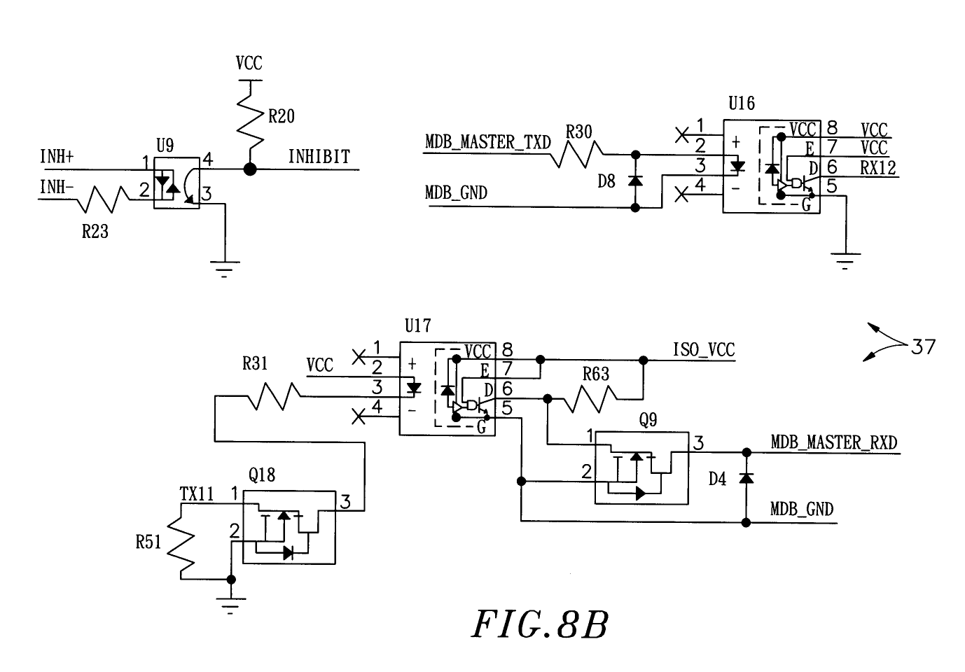

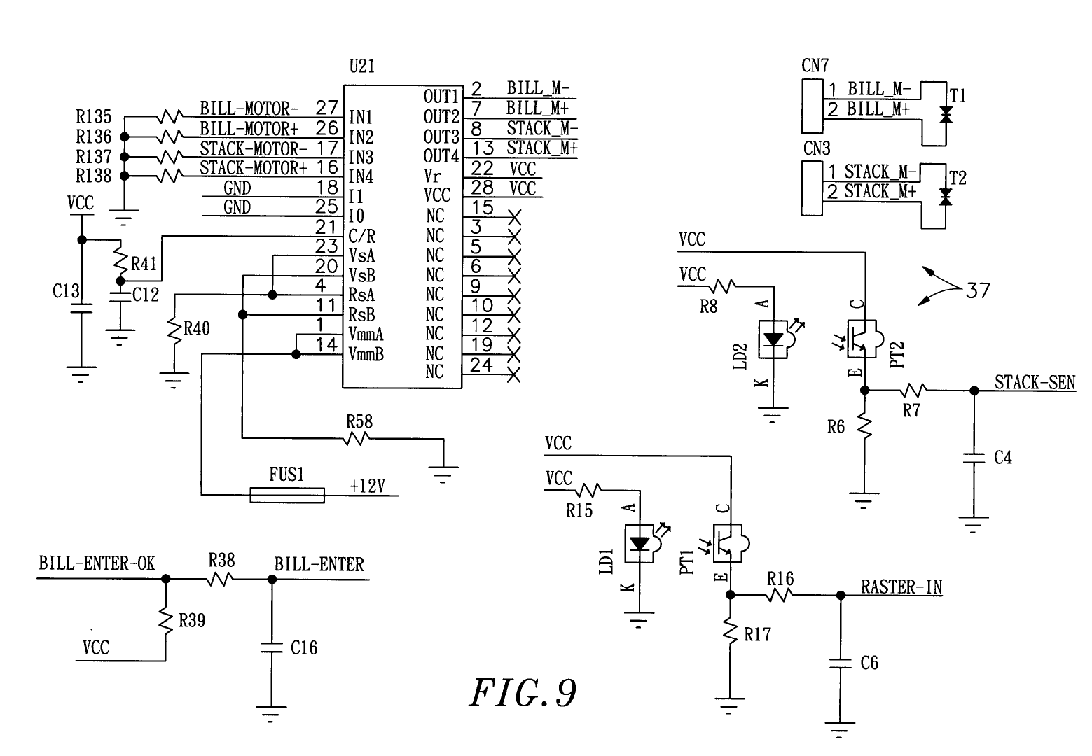

Referring to FIG. 2 and FIGS. 1 and 1A again, the banknote verification assembly 3 comprises a transmitter holder base 31, a receiver holder base 32, an optical transmitter module 33 (see also FIGS. 3 and 4), an optical receiver module 34 (see also FIGS. 3 and 5), a control unit 35 (see also FIGS. 6A, 6B, 6C, and 6D), a power module 36 (see also FIG. 7), a communication interface module 37 (see also FIGS. 8A and 8B), and a transmission module 38 (see also FIG. 9). The optical transmitter module 33 is mounted in the detection side 311 of the transmitter holder base 31. The optical receiver module 34 is mounted in the detection side 321 of the receiver holder base 32. The detection side 311 and 321 face each other, defining therebetween a banknote passage 39. The optical transmitter module 33 comprises at least one UV LED (ultraviolet light emitting diode) 331. The optical receiver module 34 comprises at least one phototransistor 341 matching the UV LED 331. The UV light of the UV LED 331 passes through the banknote passage 39 to the phototransistor 341. Therefore, when a banknote moved through the banknote passage 39, the UV light of the UV LED 331 passes through the banknote to excite the fluorescent substance in the inks of the banknote, thereby causing the photo transistor 341 to receive a fluorescent signal and then to send the signal to the control unit 35 for verifying the authenticity of the banknote.

Referring to FIGS. 1, 1A, 2 and 3 again, the power module 36 is adapted to convert external power supply into the desired working voltage for the optical transmitter module 33, the optical receiver module 34, the control unit 35, the communication interface module 37, and the transmission module 38. The communication interface module 37 is connectable to a main unit (not shown). The main unit (which can be a computer, money exchanging machine, or vending machine) controls the operation mode of the control unit 35. The transmission module 38 is installed in the conveying and banknote holding down mechanism inside the housing 1 for enabling the banknote to be delivered through the banknote passage 39 to the money box 2.

Referring to FIG. 3 again, the optical transmitter module 33 further comprises a NPN transistor 332 and a current-limit resistor 333. The base of the transistor 332 is connected to the control unit 35. The collector of the transistor 332 is connected to the UV LED 331. The emitter of the transistor 332 is connected to the current-limit resistor 333. The other end of the current-limit resistor 333 is connected to a grounding loop 334. By means of the transistor 332 and the current-limit resistor 333, the control unit 35 controls the amount of electric current to the UV LED 331, determining the intensity of UV light.

Referring to FIG. 3 again, the optical receiver module 34 further comprises a shunt resistor 342, which has one end connected to the phototransistor 341 and the control unit 35 and the other end connected to the grounding loop 343. The shunt resistor 342 controls the phototransistor 341 to regulate output voltage and to transmit the detected fluorescent signal to the control unit 35.

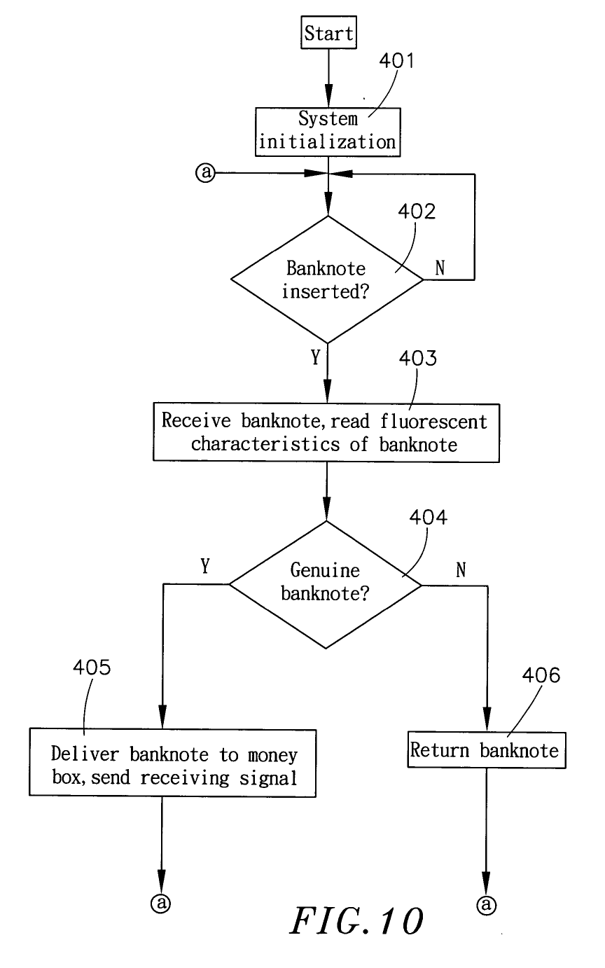

Referring to FIG. 10, when the banknote verification assembly 3 starting to verify the authenticity of the inserted banknote, the control unit 35 proceeds subject to the following steps:

(401) initializing the system;

(402) determining if there is a banknote to be verified or not? And then proceeding to step (403) if positive, or repeating step (402) if negative;

(403) receiving the inserted banknote and reading the fluorescent characteristics of the banknote;

(404) determining the authenticity of the banknote subject to the detected fluorescent characteristics, and then proceeding to step (405) if positive or step (406) if negative;

(405) delivering the banknote to the money box and sending a receiving signal, and then repeating step (402); and

(406) returning the banknote, and then repeating step (402).

A prototype of banknote acceptor has been constructed with the features of FIGS. 1˜10. The banknote acceptor functions smoothly to provide all of the features discussed earlier.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A banknote acceptor comprising:
a housing, said housing comprising an insertion slot in a face panel thereof for receiving banknote, and a conveying and banknote holding down mechanism;
a money box mounted in said housing and adapted to collect banknote from said insertion slot; and
a banknote verification assembly mounted in said housing and adapted to verify the authenticity of the inserted banknote, for enabling the verified banknote to be delivered to the inside of said money box by said conveying and banknote holding down mechanism;
wherein:
said banknote verification assembly comprises:
a transmitter holder base, said transmitter holder base having a detection side;
a receiver holder base, said receiver holder base having a detection side facing the detection side of said transmitter holder base;
a banknote passage defined between the detection side of said transmitter holder base and the detection side of said receiver holder base in communication between said insertion slot and said money box;
an optical transmitter module mounted in the detection side of said transmitter holder base, said optical transmitter module comprising at least one ultraviolet light emitting diode adapted to emit ultraviolet light onto the banknote being delivered from said insertion slot through said banknote passage;
an optical receiver module mounted in the detection side of said receiver holder base, said optical receiver module comprising at least one phototransistor adapted to receive light passing from said optical transmitter module through the banknote being delivered from said insertion slot through said banknote passage and to produce a corresponding output signal; and
a control unit adapted to receive outputted signal from said optical receiver module and to determine the authenticity of the banknote being delivered from said insertion slot through said banknote passage subject to the output signal received from said optical receiver module.

2. The banknote acceptor as claimed in claim 1, wherein said banknote verification assembly further comprises a communication interface module connectable to an external main unit adapted to set operation modes of said control unit.

3. The banknote acceptor as claimed in claim 2, wherein said banknote verification assembly further comprises a transmission module mounted in said conveying and banknote holding down mechanism for enabling the inserted banknote to be delivered from said insertion slot through said banknote passage to said money box.

4. The banknote acceptor as claimed in claim 3, wherein said banknote verification assembly further comprises a power module adapted to convert external power supply into the desired working voltage for said optical transmitter module, said optical receiver module, said control unit, said communication interface module, and said transmission module, for enabling said control unit to control the operation of said optical transmitter module, said optical receiver module, said communication interface module and said transmission module subject to a predetermined program.

5. The banknote acceptor as claimed in claim 1, wherein said optical transmitter module comprises a NPN transistor and a current-limit resistor, said NPN transistor having a base electrically connected to said control unit, a collector electrically connected to said at least one ultraviolet light emitting diode, and an emitter electrically connected to said current-limit resistor, said current-limit resistor having a first end electrically connected to the emitter of said NPN transistor and a second end electrically connected to a grounding loop for enabling said control unit to control the intensity of ultraviolet light of said at least one ultraviolet light emitting diode.

6. The banknote acceptor as claimed in claim 5, wherein said optical receiver module comprises a shunt resistor, said shunt resistor having a first end electrically connected to said at least one photo transistor and said control unit and a second end electrically connected to the grounding loop to which said current limit resister id connected.
